(19) United States
(12) Patent Application Publication
(10) Pub. No.: US 2012/0287548 A1
(43) Pub. Date: Nov. 15, 2012

(54) SURGE PROTECTOR

(76) Inventor: Chih-Hung KAO, New Patpei City (TW)

(21) Appl. No.: 13/237,748

(22) Filed: Sep. 20, 2011

(30) Foreign Application Priority Data
May 9, 2011 (TW) 100208217

(51) Int. Cl. H02H 3/22

(52) U.S. Cl. 361/118

(57) ABSTRACT

Disclosed is a surge protector which is provided before an electrical device to be protected for protecting the electrical device from harmful electrical disturbances, the surge protector comprises at least three terminals including a signal input terminal, a signal output terminal and grounding terminal; and the protector comprises; at least one circuit protecting module provided between the signal input terminal and the signal output terminal and electrically connected to the electrical device to be protected in series, thereby the circuit protecting module becomes an open circuit simultaneously when an applied voltage is greater than a safety threshold thereof in a normal mode to protect the electrical device; and at least one surge diverting module provided between an input of the circuit protecting module and the grounding terminal for directing energy of the surge to ground in a shunt mode.

### BACKGROUND OF THE INVENTION

1. Field of the Invention

The invention relates to surge protectors and more particularly to a surge protector with improved characteristics.

2. Description of Related Art

In electrical engineering, spikes are fast, short duration electrical transients in voltage (voltage spikes), current (current spike), or transferred energy (energy spikes) occurring in or out of an electrical circuit. For spikes occurring in an electrical circuit, they are almost always generated in an on/off operation of the electrical circuit. Thus, they are called switching spikes. For spikes occurring out of an electrical circuit, they are almost always generated by lightning striking the electrical circuit or a position adjacent to the electrical circuit. Thus, they are called lightning spikes.

Either switching spikes or lightning spikes can adversely affect an electrical circuit by malfunctioning the electrical circuit and shortening the useful life of electronic components thereof or even burning the electrical circuit.

It is found by thorough analysis that switching spikes are caused by switching electrical or electronic components such as relays, switches, fuses, thyristors, etc. For lightning spikes, they are caused by lightning striking an external power source.

For eliminating above switching spikes, typically a stabilization circuit (or electrical component) is connected to a node of an electrical circuit for absorbing spikes. For example, a capacitor can absorb spikes. However, it can only decrease the strength of spikes for lowering adverse effects to an electrical circuit rather than completely preventing lightning from striking it. It is known that tens or even hundreds short electrical transients with greatly increased magnitude can be generated in an electrical circuit in a microsecond by lightning strikes. A typical method of protecting an electrical circuit is immediately opening the circuit to release spike energy to the external.

Conventionally, a device for absorbing spikes or releasing spike energy to the external is employed to protect an electrical circuit. Such devices are called surge protectors. Surge protectors are appliances designed to protect electrical devices from voltage spikes. A surge protector attempts to limit the voltage supplied to an electric device by either blocking or by shorting to ground any unwanted voltages above a safe threshold. Typically, an MOV (metal oxide varistor) or GDT (gas discharge tube) is incorporated into a surge protector.

An MOV is formed by subjecting zinc oxide and bismuth oxide to sintering. MOVs are also known as spike absorbers. An MOV has properties of having a high resistance when voltage applied thereto is low and a lower resistance when voltage applied thereto is high. MOVs have different safe thresholds if their compositions are different. Resistance of an MOV may decrease greatly to pass a great amount of current therethrough when applied voltage is greater than its safe threshold. Therefore, for voltage applied to an electric device, the MOV incorporated in a surge protector electrically connected to the electric device can short to ground unwanted voltages above the safe threshold. As a result, the electric device is protected.

Another typical device for circuit protection is GDT (Gas Discharge Tube). A GDT is filled with inert gas. Typically, a GDT is connected in parallel to a circuit to be protected. A GDT has a low resistance when a high voltage is applied thereto similar to the property of an MOV. Different from MOV, a GDT can discharge energy of spikes in inert gas enclosed therein and the discharged energy is converted into heat to dissipation. As compared with MOVs, GDTs are advantageous due to higher applied voltage and higher energy absorption capability. To the contrary, MOVs are limited in power tolerance. Further, an MOV may be neutralized when its internal energy absorbing components are consumed due to excessive voltage supplied thereto.

Also, GDTs are inferior to MOVs due to its voltage precision much lower than that of MOVs. Typically, an MOV has a voltage precision of about ±10% which is much better than ±20% of the voltage precision of GDT. Moreover, a response time of a GDT is much longer than that of an MOV. Further, features such as higher withstanding voltage and cheap are advantages of GDTs. However, other features of GDTs are less desirable as compared with MOVs.

Notwithstanding prior art, the invention being cost effective and quick in response time and having higher withstanding voltage and prolonged useful time is neither taught nor rendered obvious thereby.

### SUMMARY OF THE INVENTION

It is therefore one object of the invention to provide a surge protector which is provided before an electrical device to be protected for protecting the electrical device from harmful electrical disturbances, the surge protector comprises:

at least three terminals including a signal input terminal, a signal output terminal and grounding terminal; and the protector comprises;

at least one circuit protecting module provided between the signal input terminal and the signal output terminal and electrically connected to the electrical device to be protected in series, thereby the circuit protecting module becomes an open circuit simultaneously when an applied voltage is greater than a safety threshold thereof in a normal mode to protect the electrical device; and

at least one surge diverting module provided between an input of the circuit protecting module and the grounding terminal for directing energy of the surge to ground in a shunt mode;

whereby the electrical device is protected by both the at least one circuit protecting module in the normal mode and the at least one surge diverting module in the shunt mode.

According to the present surge protector, the surge diverting module comprises a metal oxide varistor and a gas discharge tube connecting in series and the metal oxide varistor connects with input of the circuit protecting module and the gas discharge tube connects with the grounding terminal.

According to the present surge protector, a plurality of the surge diverting module can be used if necessary, i.e. comprising a plurality of metal oxide varistor and a plurality of gas discharge tube alternatively connecting in series.

According to the present surge protector, the circuit protecting module comprises at least one overcurrent protecting chip which is a doping semiconductor device. The electricity of the overcurrent protecting chip will vary depending on the voltage value input. When the input voltage is less than the upper limit of the operating voltage of the chip, the chip becomes short circuit (i.e. resistor is almost zero) so that the voltage is provided to the circuit device to be protected. If the input voltage is suddenly higher than the upper limit of the operating voltage of the chip, the chip will shut down due to the large voltage difference so that the voltage becomes blockage

The above and other objects, features and advantages of the invention will become apparent from the following detailed description taken with the accompanying drawings.

### BRIEF DESCRIPTION OF THE DRAWINGS

FIG. 1 is a circuit block diagram of surge protector according to a preferred embodiment of the invention.

### DETAILED DESCRIPTION OF THE INVENTION

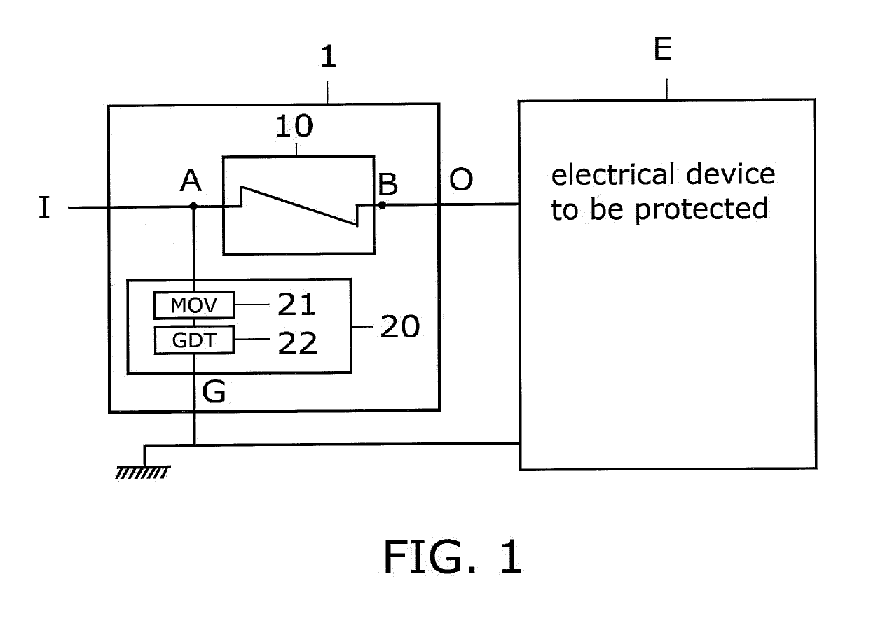

Referring to FIG. 1, a surge protector in accordance with a preferred embodiment of the invention is shown. The surge protector 1 comprises at least three terminals including a signal input terminal I electrically connected to an alternating current (AC) power source, a signal output terminal O electrically connected to an electrical device E to be protected, and a grounding terminal G. The surge protector 1 also comprises at least one circuit protecting module 10 and at least one surge diverting module 20, which are described in detail as follows.

The circuit protecting module 10 is an overcurrent protecting chip formed from doped semiconductor (i.e., extrinsic semiconductor) and provided behind an electrical device E to be protected. The input A of the circuit protecting module 10 is electrically connected to the signal input terminal I and the output B is electrically connected to the signal output terminal O and then to the electrical device E.

The surge diverting module 20 is provided between the input A of the circuit protecting module 10 and the grounding terminal G and comprises a MOV (metal oxide varistor) 21 electrically connected to the input A of the circuit protecting module 10, and a GDT (gas discharge tube) 22 having one terminal series connected to the MOV 21 and the other end connected to the grounding line G.

An operation of the invention will be described in detailed below. In a normal mode, AC has a voltage less than or equal to the operating voltage of the circuit protecting module 10. Thus, the circuit protecting module 10 is conducted (i.e., closed circuit position or on) to allow AC to supply to the electrical device E. In a shunt mode, a surge on the signal input terminal I will cut off the circuit protecting module 10 (i.e., open circuit position or off) because the surge has a voltage greater than the operating voltage of the circuit protecting module 10. Thus, the sharply increased voltage will be diverted to the surge diverting module 20. And in turn, the MOV 21 will conduct and the GDT 22 will also conduct. As a result, the surge will be passed to the ground via the MOV 21, the GDT 22, and the grounding terminal G. The circuit protecting module 10 will be returned to the normal mode immediately after the surge has been bypassed.

The circuit protecting module 10 is provided for protecting the electrical device E from surge. The circuit protecting module 10 comprises at least one overcurrent protecting chip 101 which is a doping semiconductor device. When the input voltage is less than the upper limit of the operating voltage of the chip 101, the chip becomes short circuit (i.e. resistor is almost zero) so that the voltage is provided to the circuit device to be protected. If the input voltage is suddenly higher than the upper limit of the operating voltage of the chip 101, the chip will shut down due to the high voltage difference suddenly so that the voltage becomes blockage and the high voltage (surge) will be grounded via the surge diverting module 20 and the grounding terminal G. Thus, voltage spikes are prevented from applying to the electrical device E to be protected.

In other words, power may be normally supplied to the electrical device E to be protected when applied voltage is less than the safe threshold of the chip (semiconductor device) 101 (i.e., the semiconductor device 101 being short circuited with no (or a very low) electrical impedance being encountered) in a normal mode.

To the contrary, excessive voltage supplied via the input A may cause the semiconductor device 101 to become an open circuit (i.e., circuit being interrupted due to open circuit potential (OCP)) if the excessive voltage is equal to or greater than the safe threshold of the semiconductor device 101. As a result, the electrical device E is protected. The semiconductor device 101 may operate normally to supply power to the electrical device E to be protected if the applied voltage is decreased to a value less than the safe threshold thereof, i.e., the semiconductor device 101 being short circuited with no (or a very low) electrical impedance being encountered.

The structure and doped semiconductor compositions of the semiconductor device 101 are not subjects of the invention and thus their description is omitted herein for the sake of brevity.

The surge diverting module 20 is provided between an input A of the circuit protecting module 10 and the grounding terminal G and is adapted to bypass energy of the spikes. The surge diverting module 20 comprises at least one MOV electrically connected to the input A, and at least one GDT having one terminal series connected to the MOV and the other end connected to the grounding terminal G. In the present embodiment, the MOV having higher voltage precision and quick response time (i.e., being sensitive) is provided proximate to the input A as compared with the GDT. That is, the GDT having higher withstanding voltage is provided distal the input A as compared with the MOV. Thus, the MOV having higher voltage precision and quick response time can be enabled in case of spikes. And in turn, the MOV may effectively, quickly direct energy of the spikes to the ground via the GDT and the grounding terminal G.

In the present invention, the circuit protecting module 10 and the surge diverting module 20 are compact. Thus, the surge protector of the invention can be mounted in compact LED lights or portable power supplies. The circuit protecting module 10 can suddenly become an open circuit in response to an excessive voltage applied to its input A irrespective of electrical device or circuit connected to the circuit protecting module 10. Hence, the electrical device E is protected. Subsequently, the MOV of the surge diverting module 20 is enabled by excessive voltage supplied from the signal input terminal I via the input A because the excessive voltage is greater than the safe threshold voltage of the semiconductor device 101. Resistance of the MOV thus decreases to a value of zero (or a very low). Hence, energy of the spikes are directed to the ground via MOV, the GDT and the grounding line G in a shunt mode. The semiconductor device 101 and the surge diverting module 20 will be returned to the normal mode immediately after the surge has been bypassed (i.e., having directing energy of the spikes to the ground).

It is noted that the surge diverting module 20 is provided to divert energy of the spikes to the ground and is not limited to the configuration discussed above. For example, a plurality of the surge diverting module 20 may be used, i.e. a plurality of MOVs connected in series and a plurality of GDTs are alternatively connected in series depending on applications. For instance, a surge diverting module 20 having a plurality of both MOVs and GDTs connected in series is preferred if higher voltage withstanding capability and prolonged useful life are desired.

While the invention has been described in terms of preferred embodiments, those skilled in the art will recognize that the invention can be practiced with modifications within the spirit and scope of the appended claims.

What is claimed is:

1. A surge protector electrically connected to an electrical device for protecting the electrical device from harmful electrical disturbances, surge protector comprises:
at least three terminals including a signal input terminal, a signal output terminal and grounding terminal; and the protector comprises
at least one circuit protecting module provided between the signal input terminal and the signal output terminal and electrically connected to the electrical device to be protected in series, thereby the circuit protecting module becomes an open circuit simultaneously when an applied voltage is greater than a safety threshold thereof in a normal mode to protect the electrical device; and
at least one surge diverting module provided between an input of the circuit protecting module and the grounding terminal for directing energy of the surge to ground in a shunt mode;
whereby the electrical device is protected by both the at least one circuit protecting module in the normal mode and the at least one surge diverting module in the shunt mode.

2. The surge protector of claim 1, wherein the surge diverting module comprises a metal oxide varistor and a gas discharge tube connecting in series and the metal oxide varistor connects with the input of the circuit protecting module and the gas discharge tube connects with the grounding terminal.

3. The surge protector of claim 1, wherein the surge diverting module comprises a plurality of metal oxide varistor and a plurality of gas discharge tube alternatively connecting in series.

4. The surge protector of claim 1, wherein the circuit protecting module comprises at least one overcurrent protecting chip.
